(19) United States
(12) Patent Application Publication
(10) Pub. No.: US 2014/0224185 A1
(43) Pub. Date: Aug. 14, 2014

(54) Slide Wing Pet Puzzle Toy

(71) Applicant: Kyle Hansen, Castle Rock, CO (US)

(72) Inventor: Kyle Hansen, Castle Rock, CO (US)

(21) Appl. No.: 13/765,675

(22) Filed: Feb. 12, 2013

(51) Int. Cl. A01K 15/02

(52) U.S. Cl. CPC A01K 15/025
USPC 119/710; 119/711

(57) ABSTRACT

The invention relates to a novel pet puzzle toy in which a base piece has treat receptacles which a pet must learn to solve the puzzle to obtain. Removable inserts seat in the receptacles and base coverings. The base coverings must be slid outward after the pet learns to remove the inserts which impede that movement otherwise. Thereupon the treats are exposed and pet's cognitive abilities allow it to solve the puzzle whenever treats are inserted.

### FIELD

The invention relates to a novel pet toy in which the pet must remove an insert and slide wing flap base coverings outward to expose treats located within receptacles in the base of the puzzle toy.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel pet toy wherein the pet must remove an insert and slide the wing flaps outward to expose treats located within receptacles in the base of the puzzle.

It is well known in the animal behavior sciences that is a dog doesn't get the mental stimulation it needs it will develop Behavior problems such as chewing, biting or elimination in the home due to boredom, stress or depression. Veterinary science has also determined that in addition to behavioral problems, a dog will also be more prone to diseases as the immune system can weaken due to stress or depression. Thus it is imperative to challenge a dog with activities such as the inventive toy presents.

### THE INVENTION

### Summary, Objects and Advantages

All who studied any form of psychology in school remember Pavlov's Dogs. A simple conditioning test resulted in dogs remembering or being cognitive of being given a reward when a bell was rung. Thus the dogs would respond in various cognitive ways when a bell was rung. This behavior presented itself for months after the actual tests were ceased. Pavlov evidenced that dogs actually had memory and the ability to react to certain stimuli on a consistent basis.

While it may seem sophomoric to some, exercising a dog's cognitive abilities is an important tool in keeping the animal mentally sharp, and also serves to relieve boredom that can lead to destructive behavior. Studies done by behaviorists like B. F Skinner, Pavlov and various university research groups show that even the simplest of cognitive challenges will have a positive impact on a pet. Thus, the inventive puzzle toy is an aid to that end.

In the inventive toy, the “wing flaps” rest atop the base and will slide perpendicular or outward to expose receptacles wherein pet treats have been inserted. The pet must learn not only to remove the inserts which impede movement of the wing flaps, but to slide the wing flaps outward to gain access to the treat inserted. The base of the pet toy puzzle may contain various sized treat receptacles which are incrementally exposed as the pet learns to slide the wing flap coverings outward in an increasing arc. Thus the pet can be challenged not only by the learning curve related to removing the inserts so that the wing flaps will be moveable, but to locate multiple treats by sliding the flaps out in increasing angles.

The insert pieces, which also preclude sliding of the wing flaps, are large enough so that they do not pose a choking hazard even to larger dogs. The wing flaps are hinged to the base and swing outward but do not detach. Scent holes are also located at the top of the inserts to provide greater sensory appeal to the puzzle solver.

### BRIEF DESCRIPTION OF THE DRAWINGS

The invention is described in further detail by reference to three drawings sufficient in detail to describe the invention in which:

FIG. 1 is a perspective of the slide wing pet puzzle toy depicting the base, inserts and wing flaps;

FIG. 2 is an exploded view of the toy demonstrating the wing flap open and treat receptacles exposed; and

FIG. 3 is a bottom view of the toy's base, receptacles and wing flap hinge points.

### DETAILED DESCRIPTION, INCLUDING BEST MODES OF CARRYING OUT THE INVENTION

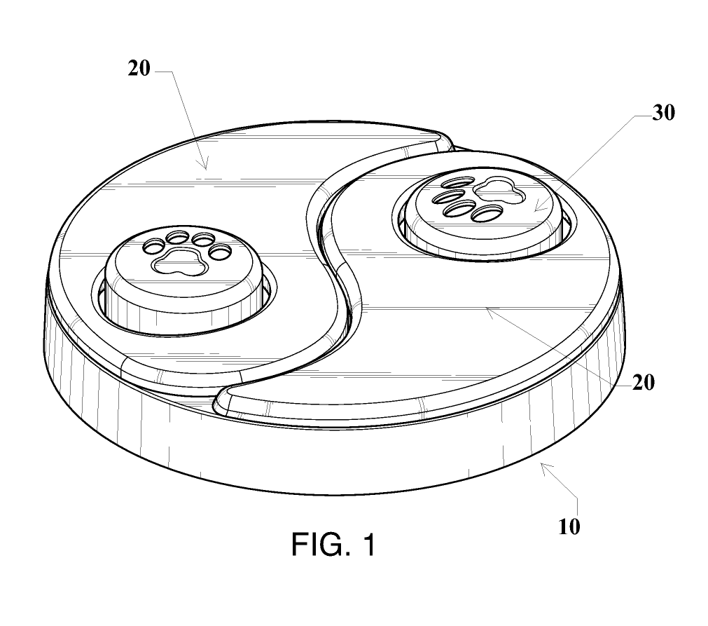

FIG. 1 shows the slide wing pet puzzle toy base 10 as undisturbed by any activity. The slide wing flaps 20 are closed and the inserts 30 are nested within the cutouts provided in the base. The animal will smell the treats and be enticed into attempting to “solve” the puzzle to gain what it smells. Holes in the top of the inserts aid in the sensory enticement.

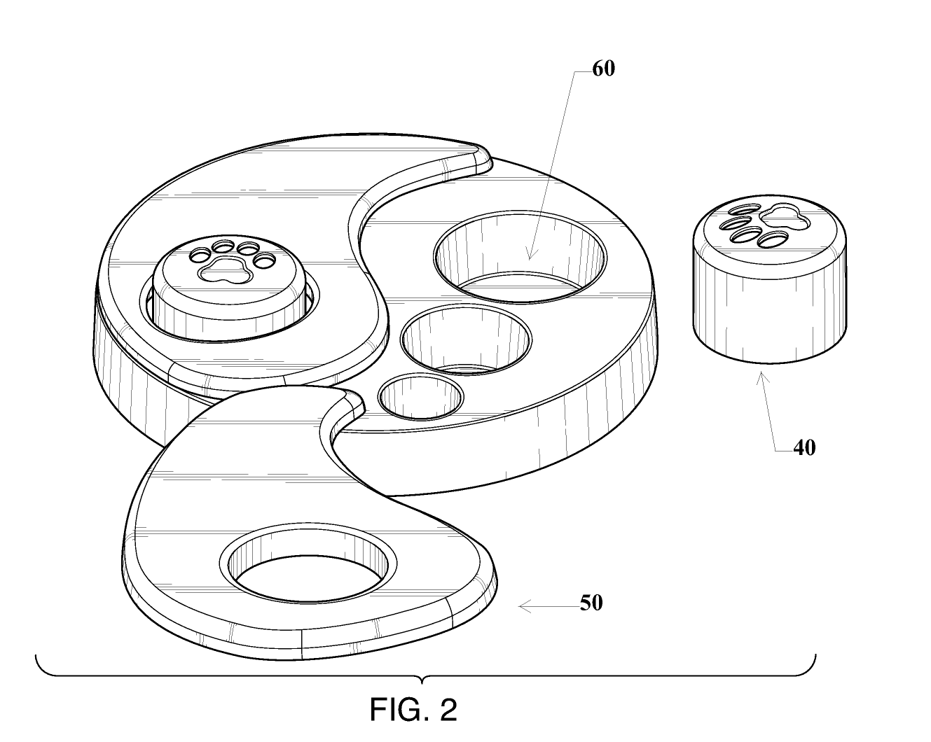

FIG. 2 illustrates the slide wing pet puzzle toy exploded to illustrate the appearance when a pet has learned to remove the insert 40 and slide the wing flaps 50 open to expose treats within receptacles 60 indented into the base. The receptacles may vary in size and are exposed as the pet learns to slide or nudge the wing flaps 50 open in a greater arc. This act conditions the pet to pursue treats until it learns it has exhausted all potential hiding places.

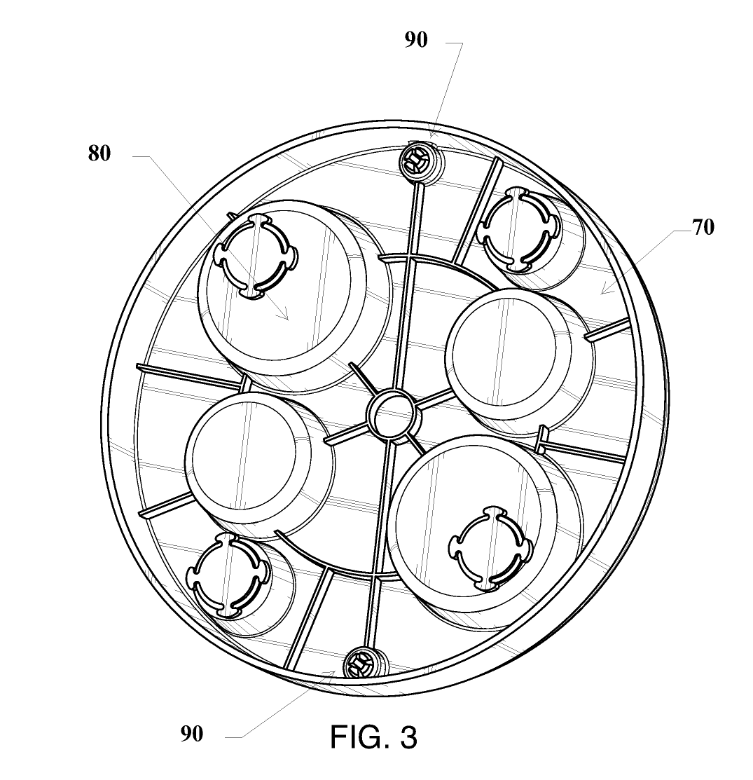

FIG. 3 is a view of the base or underside of the toy 70. The base is hollow save for the protrusion of the treat receptacles 80 which also serve to impede the wing flaps. The hinges 90 are exposed only on the underside of the base and secure the wing flaps to the base. Unlike the inserts, the wing flaps do not detach.

1) A slide wing pet puzzle toy comprising;
a) a base piece
b) hinged wing flap base coverings
c) removable inserts with scent openings

2) A slide wing pet puzzle toy as in claim 1 wherein the base piece has indented receptacles to allow pet treats to be inserted.

3) A slide wing pet puzzle toy as in claim 1 wherein two base piece coverings slide out in a winged fashion perpendicular to the base upon hinges connected therefrom.

4) A slide wing pet puzzle toy as in claim 1 wherein two circular inserts with scent openings are removable from the coverings and base simultaneously to allow wing flap coverings to be slid outward perpendicular from the base.
